(19) United States
(12) Patent Application Publication
(10) Pub. No.: US 2020/0022336 A1
(43) Pub. Date: Jan. 23, 2020

(54) BITE PREVENTION TOWEL

(71) Applicant: Miki KANEKO, Gifu (JP)

(72) Inventor: Miki KANEKO, Gifu (JP)

(21) Appl. No.: 16/545,494

(22) Filed: Aug. 20, 2019

Related U.S. Application Data
(63) Continuation of application No. PCT/JP2018/003009, filed on Jan. 30, 2018.

(30) Foreign Application Priority Data
Feb. 20, 2017 (JP) 2017-043269

(51) Int. Cl. A01K 25/00

(52) U.S. Cl. CPC A01K 25/00

(57) ABSTRACT

A bite prevention implement, wherein the bite prevention implement is made with a flexible fabric and is provided with a cord and its covers, which has a function of adjusting the width of the fabric for the length of an animal's lower jaw, the bite prevention implement is made with a flexible fabric and is provided with a cord and some loops, which has a function of adjusting the width of the fabric for the length of an animal's lower jaw, and further, the bite prevention implement is made with a flexible fabric and is provided with provided with a cord and some holes, which has a function of adjusting the width of the fabric for the length of an animal's lower jaw.

### CROSS-REFERENCE TO RELATED APPLICATIONS

This application is a continuation of International Application No. PCT/JP2018/003009, filed on Jan. 30, 2018, which claims the priority benefit of Japanese Patent Application JP 2017-043269, filed on Feb. 20, 2017. The contents of the above identified applications are incorporated herein by reference in their entirety.

### FIELD OF THE INVENTION

The present invention relates to a suitable bite prevention implement for restraining a dog's jaw joint.

### BACKGROUND

Since ancient times, canine was the first able animal that humanity have ever known. Canine was the special animal to be raised in precious, so that canine work for their owner in faithfully. For this reason, a variety of working dog created, and humanity are supported and coexist with each other. At the present time, dogs were given training have acted as working dog in a wide variety of fields. However, most dog have become popular as house dog, and are treated as a member of the family and plays a role as a companion creature. The general in the main have kept dog indoor, so that their life mode become different with the times. There is a need to periodically pass pet grooming parlor and to receive trimming for hygiene control. The opportunity to receive veterinary hospitals is increased, so that most injury and disease can be treated. Because of the development of veterinary practice act is accompanied by advances in medicine. In dog and cat which are representative of companion creature, high-level medical service may be selected in some cases. At least, as a health management for dog, the owner has a formal obligation to receive preventive cares for infectious diseases which is main of rabies and filaria.

However, it is large stress for dog to go to a strange place, and to get various treatments. In case of staffs of a pet grooming parlor or a veterinary hospital handle a dog does not touch another person, there is a problem that the bite wound is not cut off. If a dog more than a medium-size dog caught staffs, it will be subjected to a large injury, so that the force of the dog's jaw is strong. Also, it is a trouble of the owner, in a state where the service is not received such a too sensitive and attacking dog.

Conventional muzzles are difficult to put on aggressive dogs. Therefore, in case of to treat aggressive dogs, there is a countermeasure in typically service business of pets, staffs have replied on the method to inject abirritant and anesthetic.

Conventionally, muzzles have been used to prevent dog's bite. The type of muzzles is disclosed in US patent. In patent document 1, it is suggested and disclosed that the muzzle includes a muzzle body having a flexible webbing with two strap channels for a semi-flexible strap. In patent document 2, it is disclosed that the muzzle which the device allows for an opening to be procured on either or both sides at one time on a muzzle that is at the same time being used to hold the mouth of the animal closed. Also, as disclosed in patent document 3, there is also a muzzle for controlling the action of a dog which the device includes a collapsible hood having a length extending between a collar end and a muzzle end.

### DESCRIPTION OF THE PRIOR ART

### Patent Documents

Patent document 1: US 2016/0360732 A1, Adjustable Animal Muzzle (Jarred, Lyons)
Patent document 2: US 2012/0178041 A1, Windowed Muzzle to Facilitate Oral inspection (Cogley, Thomas Paul)
Patent document 3: US 2013/0152875 A1, Device for Controlling Animal Behavior by Altering Sensorial Input Cues (Levine, Joshua D.)

To catch and take an aggressive dog up one's arm is a task requiring courage and gone with danger. An aggressive dog is caught when a catcher attaches a protector to one's arm and one is bitted into the dog, then the drug of sedative is injected. However, when human breast from the front of dog, it will be a menacing behavior for the dog. Therefore, the dog has fallen into a vicious circulation in which the dog tries to operate in aggressive for defense. It will produce heart failure of dog, when one tries to catch aggressive dogs. So that the stress applied to a dog is large, some accidents which are caused by sudden death of dog have occurred frequently. The administration of the abirritant and anesthetic also likely to death in an accident of dog, because of it will place a burden on the dog.

### SUMMARY OF INVENTION

### Problem to Be Solved By the Invention

At the present time, to provide an appropriate management for keeping dog, it is on the assumption that dog receive services with respect to trimming and veterinary practice act. Dog are necessary to be treated by a trimer or a veterinarian, when a dog has to be touched by another person. On this occasion, to prevent accidental biting from a catcher and an operator, there is a need to put a bite prevention implement on a dog. It is also a subject that to provide an anti-bite implement which can be quickly putted and has less stress for dog.

### Means for Solving the Problem

The bite prevention implement of the present invention is made with a flexible fabric in such a way that is used as a main part. It has a width covering the dog's entire lower jaw and a length covering the whole head other than the nose. And in the center of the flexible fabric, it is adapted to provide with a cord and one set of covers for adjusting the length of the jaw corresponding to the individual dog. To tighten and loosen this cord is adapted to use cord stoppers, or it may be tied by one's hands. The other means for shortening the width of a fabric by using a cord, it is that some loops are provided with the fabric and it is to pass the cord. Or in the alternative, to make some holes in the fabric, and to pass the cord is that the gathers are formed. It will be in conformity with most big-size dog provided that this fabric of width is made in 30 cm.

Both side part of the flexible fabric adapted to so as to anchor the neck from the back head of a dog, it is connected at the extreme tip having a buckle as a fastening part. The connection part of the belt is formed by directly sewing and the other side of the fabric has a hook (snap button) is used for fitting. Alternatively, it is possible improvement that if both of the fabric were connected to the belt by using a hook, and it will be removable form. If the buckle used for the fastening part were used a type capable of step-less adjusting the length of the belt, it will be equal to a size of a tight collar fitted to individual dog.

Both ends of the flexible fabric are adapted to be attached a belt which keeps at a safe distance from a dog. The distance from a dog which is adjusted by the belt, it is more than long enough for the dog's jaw from the shoulder. In case of this belt are not provided, it is possible to make the flexible fabric longer so as to get the same effects. Under conditions in which the flexible fabric has a total length of 1 m˜1.5 m, it is reasonable that the distance from a dog keeps more than 50 cm.

In a flexible fabric is wound around a dog's jaw, a touch part in which the right and left of the center of the fabric is adapted to one set of hook-and-loop fasteners, in such a way that which are positioned at a dog's forehead from the nose bridge.

A cord for binding and cord-stopper are installed at the top edge of the flexible fabric, and a plurality of hooks is adapted to provide with the center of the cloth. To tie alternate the hook with the cord, then the dog's whole jaw is cinch tightened, it is securely to hold a jaw joint.

A portion in touch with a dog's nose, at the top edge of the flexible fabric, a pad made with a hardness and resilient material is attached to prevent choke. In this respect, a space is formed when it is used in such a way that the nose is removed from the fabric.

The catcher holds by one's right and left hands the belts attached to both ends of the flexible fabric as the present invention, and it forms into a U shape. The dog is stood up the rear limb, and the posture is fixed by attaching the front limb to the wall. A flexible fabric is passed through the chin, it is like to catch this cloth from the back of the dog. Both arm of the catcher is crossed to tighten the dog's jaw with fabric, then the belt is connected at the dog's back of head. In this respect, the whole head except the nose of the dog is covered with the fabric. Since the present invention blocks the dog's view, the action of the dynamic vision can be suppressed. The flexible cloth having a length from the dog's jaw to the one's hands is used, so that there is less risk of that the catcher is bitten. In this procedure, the movement of the dog's jaw joint can be quickly sealed.

When the flexible fabric as the present invention is wound around a dog's jaw, a pair of hook-and-loop fasteners are attached so as to be adhered to the dog's forehead from the nose bridge. If the shape of the hook-and-loop fastener were made trapezoidal or triangular in the deepen angle, it will be possible to adjust the thickness of the chin to the size of individual dogs. As a result, the area to be adhere is large, it is possible to correspond the dog breed (Bulldog) which has a short jaw and thick chin.

### Effects of the Invention

The present invention has the following effects and advantages:
(1) By means of using a flexible fabric of the width is telescopically and wound around a dog's head in central of the jaw, the present invention can deal with the form of the jaw for different dog types. Further, the size can be adjusted to corresponding to the individual dogs.
(2) By means of the belts are attached to both ends of a flexible fabric and the length is extended, it keeps at a safe distance from a dog. It has less risk of bitten accident for a catcher.
(3) By the technique of using a long and flexible fabric, it is possible to restrain quickly a dog's jaw joint of the movement.
(4) Since a dog is retained from the back of the dog, the dog is not attacking. Further, a catcher does not confront a dog, the number of bitten accidents will decrease. Since, it doesn't place a burden on dog without injecting drug.
(5) By means of the flexible fabric covers a dog's whole head other than the nose, it has an effect of blinding. The dog does not work at dynamic vision, and the excitement on the surrounding motion is suppressed. Thereby, it will be facilitated to maintenance of a dog's body both nail-cutting and shampoo, also medical treatment.

### BRIEF DESCRIPTION OF DRAWINGS

FIG. 1 is a general view of a bite prevention towel according to the present invention;

FIG. 2 is a diagram showing a method of using the bite prevention towel according to the present invention;

FIG. 3 is a diagram which is putted on a dog the bite prevention towel, according to the present invention;

### DETAILED DESCRIPTION OF THE PREFERRED EMBODIMENT

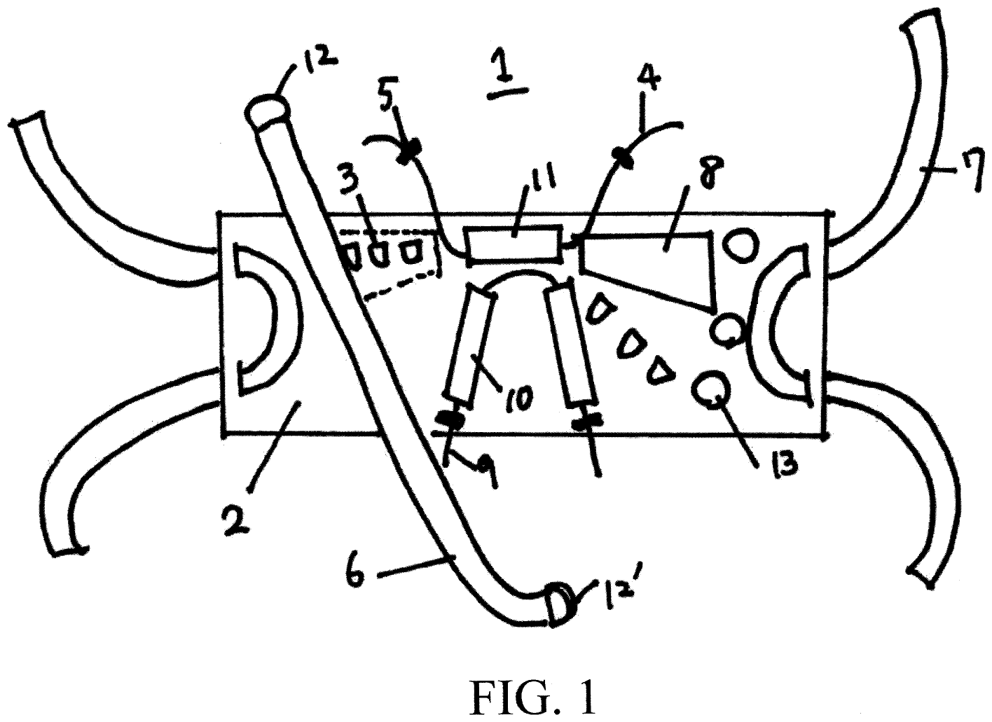

FIG. 1 is a bite prevention implement according to the present invention. The bite prevention implement 1 is formed the flexible fabric 2 as a main part. It has a width covering a dog's entire lower jaw of a dog and a length covering the whole head other than the nose. The material of the flexible fabric 2 is likely for nylon. A pair of hook-and-loop fasteners 8 (8: surface of cloth, 8′: back surface of cloth) are provided on the right and left of the flexible fabric, the fabric adapts to be adhered when the fabric is folded up. A plurality of hooks 3 are attached to the center of the flexible fabric 2, so as to keep to cinch tight a dog's whole of jaw when it is putted on the dog, and the cord 4 is tied alternate on the hook. In this cord of the left and right, the stopper 5 are attached, so as to keep the length of the bound cord. As the material of the cord, nylon is suitable.

Two belts for holding neck from the dog's back is provided on both side of the flexible fabric 2. A holding belt 6 has a snap button 13 as a connection part with the fabric, the buckle 12 is provided on the top of edge the belt as tie. Also, the flexible fabric 2 on the both ends has the belt 7 for keeping at a safe distance from a dog.

In the center of the flexible fabric 2, the cord 9 is installed which is passing through under a pair of covers 10. By means of the cord is to be bound and loose, the cord is adjusted to the length of a dog's jaw fitted to the individual of the putted dog. A cord 9 on the right and left has stopper 5′, it is adapted to keep the length of cinch tight. A pad 11 is installed at the top edge of the flexible fabric 2. As a result, a space can be formed at the time of putting a dog, so that it has a function of removing the nose from the fabric and preventing to be choked. The pad 11 also serves as a cover of the cord 4, and the cord 4 passes under. The pad 11 is best for shoulder tape derived from acrylic.

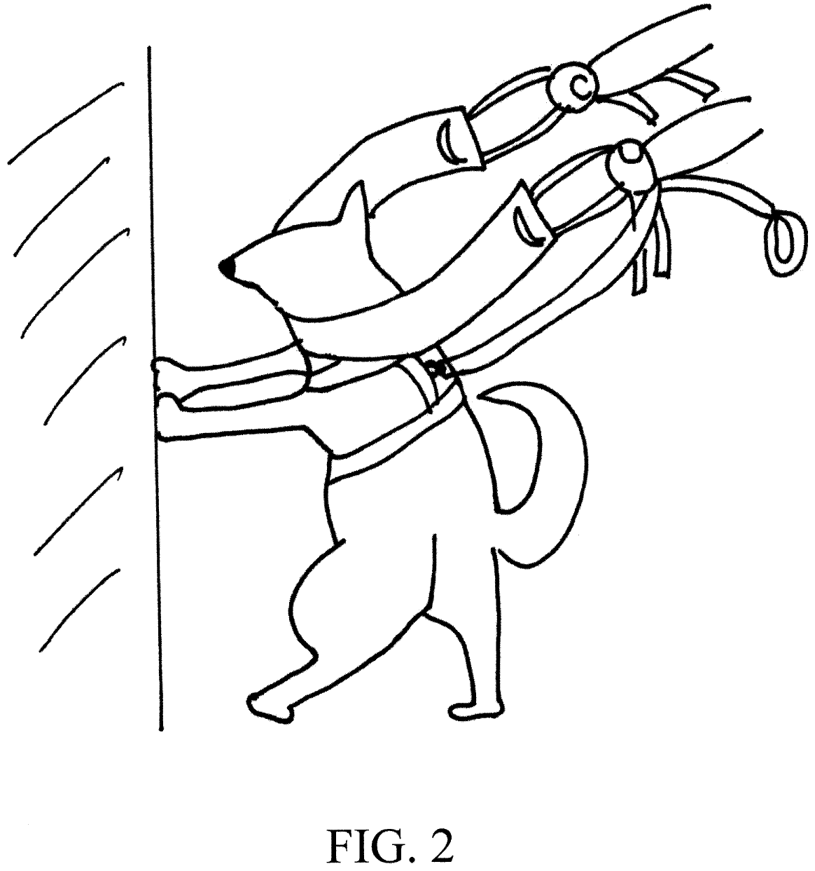

FIG. 2 is a view showing a method for using a flexible fabric (FIG. 1) according to the present invention. A method for putting a flexible fabric on a dog is described below. A catcher has a lead to shorten and a dog putted a harness connected the lead. Then the catcher lifts the dog is in a standing posture with lead and harness. It needs to make dog stand with after paw, to touch dog on the wall. Under the condition that dog can't move, the catcher has a flexible fabric on the dog's head from the back. The catcher stands at the back of dog, and a belt attached to the right and left of the flexible fabric is gripped by both hands, then the flexible fabric is formed into a U-shape. The flexible fabric is passed through the dog's chin, the catcher's right and left arms are crossed and wound around the jaw. The flexible fabric surrounds the dog's jaw, at the area which the fabric crossed the dog's forehead from the nose bridge, it is adhered to hook-and-loop fastener 8. Further, the flexible fabric has crossed at the dog's back-head, a holding belt have tightened up. In this respect, the dog's jaw and head are tightened up into an 8-shape, in a state where the flexible fabric has been looped around the dog's whole of head more than one cycle.

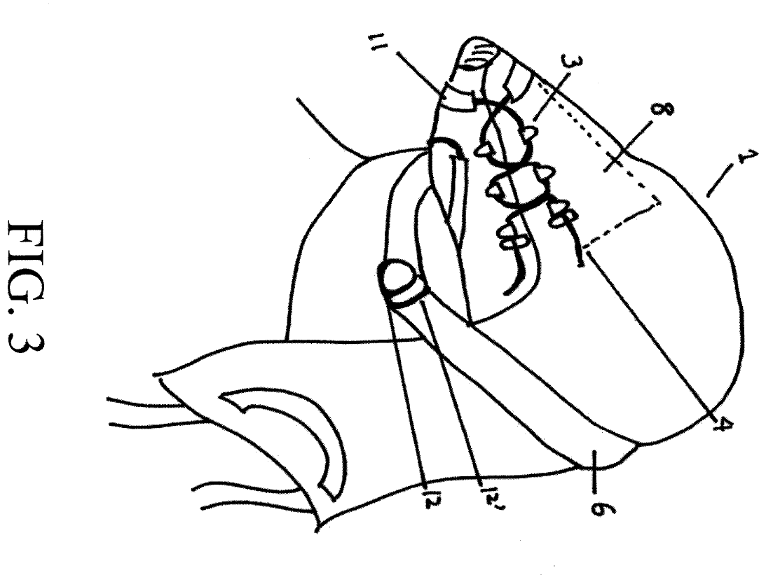

FIG. 3 is drawing that shows a dog is putted on a bite prevention implement according to the present invention. The flexible fabric covers the dog's whole head other than the nose, and it shows that in a state of being adhered with a hook-and-loop fastener 8. Further, the dog's entire jaw is fastened and retained by hook 3 and cord 4, it will be a state of being fastened from the back head to the neck by the belt 6. The flexible fabric has a length to be tightened up into an 8-shape includes a dog's jaw and head, and has width covering the entire lower jaw. The method for ligating fabric formed into an 8-shape is strong for the restraining force, so that the dog's force applied to the lower jaw is suppressed even in the back-head. Further, a part of the fabric which touches the dog's nose is attached to the pad. The pad makes to form a space at the time of putting in such a way that the nose is removed from the fabric. Since the dog is covered with the fabric, the dog does not react to the surrounding movement in too-sensitivity. The dog's excitation is suppressed, various treatment will be facilitated.

### INDUSTRIAL APPLICABILITY

According to the present invention, there is little danger that a catcher is bitten by a dog, and it is possible to restrain the dog's jaw of movement. It is not necessary to inject abirritant and anesthetic, there is no burden on the dog and no expense. Because of a catcher does not confront a dog, this method is safe to catch animals and there are little bitten accidents. Further, since the dog is blinded by the fabric, the dog does not react to the motion of the surrounding in too-sensitivity. In this respect, this method facilitates maintenance of the dog's body and getting medical treatment, it will contribute to improve the management of the dog's owner.

The present invention can be applied not only to dog but also to other animals. To provide a flexible fabric capable of freely adjust the width, it is wound around an animal's head in central of the jaw. In this respect, it can be putted on regardless of the animal's shape and size. Accordingly, this invention can deal with any animal. It is expected that the present invention will be used in biological observations of wild animals and zoological gardens.

### DESCRIPTION OF SYMBOLS

1: bite prevention implement 2: flexible fabric 3: hook 4: jaw binding cord 5: cord stopper (5: cord stopper A, 5′: cord stopper B) 6: holding belt 7: extension belt 8: hook and loop fastener (8: surface of the cloth, 8′: back surface of the cloth) 9: jaw adjustment cord 10: cover 11: pad 12: buckle (12: ring A, 12′: ring B) 13: snap button

1. A bite prevention implement, wherein
the bite prevention implement is made with a flexible fabric and is provided with a cord and its covers, which has a function of adjusting the width of the fabric for the length of an animal's lower jaw;
the bite prevention implement is made with a flexible fabric and is provided with a cord and some loops, which has a function of adjusting the width of the fabric for the length of an animal's lower jaw;
further, the bite prevention implement is made with a flexible fabric and is provided with provided with a cord and some holes, which has a function of adjusting the width of the fabric for the length of an animal's lower jaw.

2. A bite prevention implement, wherein
the bite prevention implement is provided with a pad attached to the top edge of a flexible fabric, which has a function of preventing animals to be suffocated;
the bite prevention implement forms a space when putted on an animal and exposes the nose from the fabric.

3. A bite prevention implement, wherein
the bite prevention implement is made with a flexible fabric;
the length of the bite prevention implement covers an animal's back head to the center of the jaw and the width of implement covers the lower jaw;
the bite prevention implement has a function of winding and tightening an animal's jaw joint;
the bite prevention implement covers the whole head other than the nose when putted on an animal.
